(19) United States
(12) Patent Application Publication
(10) Pub. No.: US 2026/0003184 A1
(43) Pub. Date: Jan. 1, 2026

(54) COMPACT OBSERVATION DEVICE CONFIGURED TO OVERLAY AN IMAGE OF AN OBSERVED SCENE AND A PROCESSED IMAGE OF THE OBSERVED SCENE

(71) Applicant: SAFRAN ELECTRONICS & DEFENSE, Paris (FR)

(72) Inventors: Arnaud Davenel, Moissy-Cramayel (FR); Laurent Trouboul, Moissy-Cramayel (FR); Bastien Deloison, Moissy-Cramayel (FR); Yacine Othmani, Moissy-Cramayel (FR)

(21) Appl. No.: 18/880,735

(22) PCT Filed: Jul. 3, 2023
(86) PCT No.: PCT/FR2023/051009

§ 371 Date: Jan. 2, 2025

(30) Foreign Application Priority Data
Jul. 8, 2022 (FR) FR2207015

(51) Int. Cl. G02B 27/01; G02B 23/04; G02B 23/10

(52) U.S. Cl. CPC G02B 27/0101; G02B 23/04; G02B 23/10

(57) ABSTRACT

Disclosed is an observation device comprising a mechanical structure, a camera and a display module comprising a first micro-display configured to display an image of an item of spectral information measured by the camera, the observation device comprising an optical combiner and an arrangement of optical components configured to direct, to the optical combiner, an image output by the display module and comprising the item of spectral information displayed by the first micro-display, the arrangement of optical components comprising between one and three optical surfaces, the optical combiner directing the overlaid image of an observed scene and the image output by the display module to an observation zone.

### TECHNICAL FIELD

This invention relates to an observation device enabling an operator looking through the device to see an overlay of at least one spectral and/or contextual piece of information on an observed scene.

In particular, the present invention enables an image of the observed scene to be overlayed on an image displayed by at least one microdisplay.

One application of the invention relates to rifle scope, although the invention may also relate to binoculars or optical apparatuses in automotive vehicles.

### PRIOR ART

FIG. 1 schematically represents a rifle scope 2 known from prior art. Such a rifle scope 2 makes it possible to overlay on an image of a scene observed by an operator a red dot and an image of the observed scene acquired by a thermal camera 4 of the rifle scope 2.

The thermal camera 4 comprises an infrared objective lens 6, power electronics 8 and an infrared sensor 10. The thermal camera 4 is configured to capture and transmit an infrared image of the observed scene to a display 12 on the rifle scope 2, the display 12 displaying the image transmitted. A second display 14 on the rifle scope 2 displays an image of the red dot.

The rifle scope 2 comprises an optical combining device 16 configured to overlay the infrared image of the observed scene and the image of the red dot. The rifle scope 2 also comprises a large number of optical components, herein three lenses 18 and a plane mirror 20. The image overlayed by the optical combination device 16 is directed towards a semi-reflective plane plate 22 by the three lenses 18 and the plane mirror 20. The semi-reflective plate is configured to direct the superimposition of the image overlayed by the optical combination device 16 and the observed scene towards an eye 24 of the operator. The rifle scope 2 also comprises a power supply unit 25 configured to supply power to the displays 12, 14.

The rifle scope 2 represented in FIG. 1 necessarily comprises a large number of optical components positioned between the optical combining device 16 and the semi-reflective plane plate 22 in order to correct optical aberrations and direct an image of the scene of sufficient quality towards the operator's eye. These numerous optical components make the rifle scope 2 cumbersome and heavy.

### DISCLOSURE OF THE INVENTION

The purpose of the present invention is therefore to overcome some or all of the aforementioned drawbacks.

One object of the present invention is an observation device comprising a mechanical structure, a camera and a display module comprising a first microdisplay configured to display an image of a spectral piece of information measured by the camera, the observation device comprising an optical combiner and an arrangement of optical components configured to direct towards the optical combiner an image output by the display module and comprising the spectral piece of information displayed by the first microdisplay, the arrangement of optical components comprising between one and three optical surfaces, the optical combiner directing towards an observation zone the superposition of an image of an observed scene and of the image output by the display module.

Thus, the present invention provides an observation device with reduced dimensions relative to a prior art device with similar optical performance.

According to a first design, the arrangement of optical components is an arrangement of free-form type optical components comprising between one and three free-form type optical surfaces.

According to a second, alternative design, the optical combiner is of the free-form type.

Advantageously, the optical combiner is of the free-form type, the arrangement of optical components being an arrangement of free-form type optical components comprising between one and three free-form type optical surfaces.

Preferably, the optical combiner comprises a free-form type dichroic filter or a free-form type semi-reflecting mirror or a free-form type splitter cube.

Optionally, the free-form type optical combiner comprises a free-form optical component comprising two identical surfaces translated from one another along a line of sight of the scene so as to be of constant thickness along the line of sight.

In one embodiment, the observation device comprises a moving attenuating filter configured to be placed upstream of the optical combiner on an optical path of light rays passing through the optical combiner.

Advantageously, the arrangement of optical components comprises at least two free-form type optical surfaces.

Optionally, the arrangement of optical components comprises three free-form type optical surfaces.

In one embodiment, the first microdisplay is also configured to display at least one contextual piece of information.

Preferably, the display module comprises a second microdisplay configured to display at least one contextual piece of information and a second optical combiner configured to overlay the image from the first microdisplay and the image from the second microdisplay so that the image output by the display module also comprises the contextual piece of information displayed by the second microdisplay.

Optionally, the display module comprises one or more additional microdisplays each associated with an additional camera and configured to display an image of additional spectral piece of information measured by said associated camera, the display module comprising one or more additional optical combiners configured so that the image output by the display module also comprises the information displayed by the additional microdisplays.

Advantageously, the surfaces of the optical components are defined from Zernike polynomials. The optical components comprise, for example, a free-form type optical surface and/or an optical combiner.

### BRIEF DESCRIPTION OF THE DRAWINGS

Other purposes, characteristics and advantages of the invention will appear upon reading the following description, given solely by way of non-limiting example, and made with reference to the appended drawings wherein:

FIG. 1 already mentioned schematically illustrates a rifle scope according to prior art;

FIG. 2 schematically illustrates an observation device according to a first embodiment of the invention wherein the arrangement of optical components comprises a free-form type optical surface;

FIG. 3 schematically illustrates an observation device according to a second embodiment of the invention wherein the arrangement of optical components comprises two free-form type optical surfaces;

FIG. 4 schematically illustrates an observation device according to a third embodiment of the invention wherein the arrangement of optical components comprises three free-form type optical surfaces;

FIG. 5 schematically illustrates an observation device according to a fourth embodiment of the invention wherein the arrangement of optical components comprises three free-form type optical surfaces, the display module comprising two microdisplays; and

FIG. 6 schematically illustrates an observation device according to a fifth embodiment of the invention wherein the arrangement of optical components comprises two free-form type optical surfaces, the display module comprising four microdisplays and three additional optical combiners.

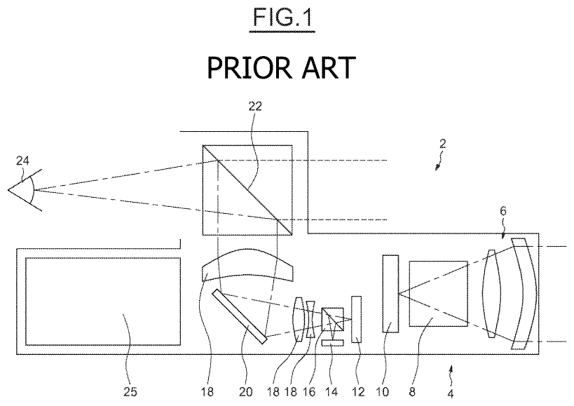

### DETAILED DESCRIPTION OF AT LEAST ONE EMBODIMENT

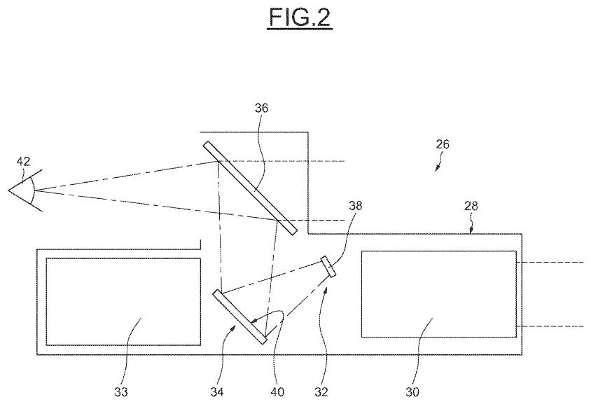

FIG. 2 schematically represents an observation device 26 according to a first embodiment. The observation device 26 comprises a mechanical structure 28, a camera 30, a display module 32, an arrangement of optical components 34 and an optical combiner 36. Preferably, the camera 30, the display module 32, the arrangement of optical components 34 and the optical combiner 36 are disposed inside the mechanical structure. Advantageously, the arrangement of optical components 34 comprises free-form type optical components and the optical combiner 36 is of the free-form type.

By “free-form” type optical component, it is meant an optical component whose surfaces can be machined or moulded so as to form complex surfaces. “Free-form” optical components designate optical components or optical surfaces designed with little or no symmetry, i.e. asymmetry, for example an optical component which does not comprise an optical axis and/or at least one surface of which has no symmetry of revolution. The “free-form” technology applied to an optical component is particularly useful for correcting optical aberrations normally present in so-called standard optical components, in other words comprising an optical axis and/or symmetry of revolution.

The observation device 26 is configured to be oriented towards a scene to be observed. The scene observed is, for example, a person between two trees. It is known that the spectral emission of a person is different from that of the trees surrounding them. In another embodiment, the scene observed is, for example, an automotive vehicle travelling on a road or a high-altitude hot object such as an aircraft.

The thermal camera 30 comprises, for example, an infrared objective lens, power supply electronics and an infrared sensor (not represented).

The display module 32 herein comprises only a first microdisplay 38, for example an OLED display. The first microdisplay 38 is configured to display an image of a spectral piece of information measured by the camera 30. The spectral piece of information measured by camera 30 comprises, for example, an infrared image of the observed scene. In another exemplary embodiment, the spectral piece of information comprises an image of the observed scene filtered according to one or more spectral bands, for example one or more visible or infrared spectral bands. Preferably, the camera 30 comprises processing electronics configured to apply digital processing to the spectral piece of information measured by the camera 30, for example measurement noise attenuation processing and/or measurement filtering, so that the image displayed by the first microdisplay 38 comprises an image digitally processed by the camera 30.

Preferably, the observation device 26 comprises a power supply unit 33 configured to supply power to the display module 32.

The arrangement of optical components 34, advantageously of the free-form type, is configured to direct an image output by the display module 32 to the optical combiner 36. In the example illustrated in FIG. 2, the image output by the display module 32 is the image displayed by the first microdisplay 38.

The arrangement of optical components 34 herein comprises exactly one optical surface 40, advantageously of the free-form type. By optical surface 40, it is meant a surface separating two media of different refractive index or a reflective surface. An optical surface is counted when light rays circulating in the observation device 26 strike said optical surface. For example, a free-form type mirror comprises one free-form type optical surface, a free-form type converging lens comprises two free-form type optical surfaces, a free-form type prism comprises three free-form type optical surfaces for the light passing therethrough: two refractive surfaces and one reflective surface.

The image output by the display module 32 is herein reflected by the optical surface 40, advantageously of the free-form type, and is then directed towards the optical combiner 36.

The optical combiner 36 is advantageously of the free-form type and configured to direct towards an observation zone 42 the superimposition of an image of the observed scene and the image output by the display module 32 redirected by the optical surface 40. For example, the optical combiner 36 transmits the image of the observed scene and reflects the image coming from the display module 32. The observation zone 42 comprises, for example, a zone for accommodating a human operator's eye. In another embodiment, the optical combiner 36 reflects the image of the observed scene and transmits the image output by the display module 32 so as to superimpose the image of the observed scene and the image output by the display module 32.

Preferably, the optical combiner 36 comprises a free-form optical component comprising two identical surfaces translated one relative to the other along a line of sight of the observed scene. The thickness of said free-form optical component along the line of sight is therefore constant. Light rays passing through said optical component are not deflected. The optical combiner 36 thus does not distort the image of the observed scene transmitted by the optical combiner 36.

The optical combiner 36 comprises, for example, a free-form type dichroic filter or a free-form type semi-reflective mirror or a free-form type splitter cube or an assembly of free-form type prisms. Advantageously, the choice of optical combiner 36 enables an architecture of the observation device 26 that is more compact and/or lighter.

Optionally, the surfaces of the optical combiner 36 and the optical surface 40 comprise a dielectric or anti-reflective treatment.

The observation device 26 of FIG. 2 is a simple embodiment of the invention, particularly suitable for equipping automotive vehicles so as to provide a driver of the vehicle with useful information to make a driving decision. For example, the observation device (26) is equipped with a rear-view mirror to improve visibility of another automotive vehicle or a pedestrian, for example in low-light conditions. In another exemplary embodiment, the observation device 26 is particularly adapted for a head-up display of an automotive vehicle, for example for directing towards the eye of a driver of the vehicle the superimposition of a road on which the vehicle is travelling and information useful to make a driving decision comprising, for example, the highlighting of white lines of the road or edges of the road or vehicles travelling on the road, for example in a low-visibility situation.

The use of a free-form type optical combiner 36 and a free-form type optical surface 40 especially makes it possible to greatly reduce optical aberrations in the observation device 26. Optical aberrations comprise, for example, spherical aberration and/or coma and/or astigmatism and/or field curvature and/or distortion.

The use of a free-form type optical surface 40 such as a free-form type mirror makes it possible to limit sensitivity of the observation device 26 to chromatism.

The free-form type optical surface 40 is, for example, formed of optical polymers by a moulding method which especially reduces manufacturing errors on the optical surface 40. Optical polymers comprise, for example, several materials whose trade names are ZEONEX, ULTEM, EXTEM, TOPAS, OKP4, LUCITE, LEXAN and LUSTREX. Advantageously, the materials used for the optical surface 40 are selected to have a refractive index of between 1.3 and 1.9 and are particularly adapted for use at visible wavelengths. Materials with a higher refractive index can be used, for example strontium titanate or a material with a refractive index close to 2.4. Preferably, the optical components especially of the free-form type described hereinafter are of similar construction.

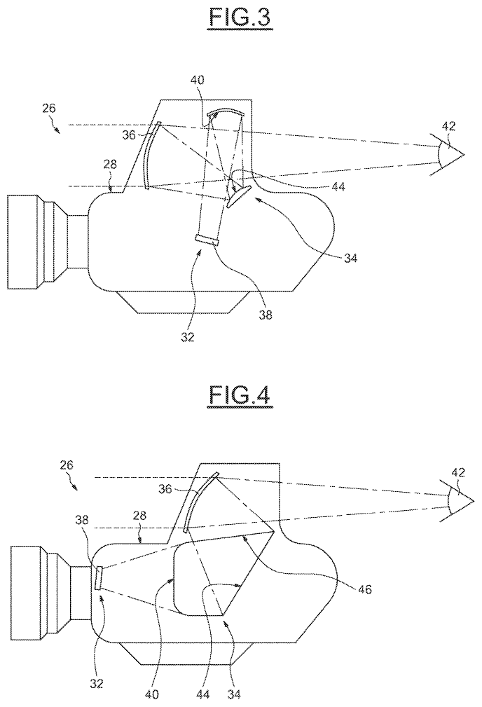

FIG. 3 schematically illustrates an observation device 26 according to a second embodiment wherein the arrangement of optical components 34 comprises two optical surfaces 40, 44 advantageously of the free-form type.

The display module 32 is similar to the first embodiment. Light rays making up the image output by the display module 32 are directed towards a first optical surface 40, herein a free-form type mirror. Light rays are reflected and directed towards a second optical surface 44, herein a second free-form type mirror. Light rays are again reflected and directed towards the optical combiner 36, advantageously of the free-form type. The optical combiner 36 is similar to the first embodiment.

The optical combiner 36 transmits the image of the observed scene and reflects the image output by the display module 32 redirected by the two free-form type optical surfaces 40, 44 so as to overlay both images.

Light rays making up the image output by the display module 32 are reflected three times before reaching the observation zone 42. This embodiment is particularly advantageous to correct a large number of optical aberrations. Indeed, three mirrors make it possible to create an anastigmatic system and thus minimise the three main optical aberrations namely spherical aberration, coma and astigmatism. Advantageously, the second embodiment illustrated in FIG. 3 forms of an observation device 26 configured to provide in the observation zone 42 an image at the diffraction limit, in other words an image whose resolution is limited only by diffraction.

In another embodiment, the two optical surfaces 40, 44 are replaced with a free-form type lens, the arrangements of the different elements inside the mechanical structure 28 being adapted accordingly.

In a particular embodiment, the mechanical structure 28 comprises at least one moving attenuating filter movable between at least two positions. In a first position, the attenuating filter is placed upstream of the optical combiner 36 in an optical path for light rays coming from the observed scene and directed towards the optical combiner 36. The optical combiner 36 especially makes it possible to attenuate light rays coming directly from a major light source such as the sun and/or to attenuate light rays coming from the observed scene. The attenuating filter makes it possible to adjust the ratio of luminous intensity of light coming from the observed scene and light coming from, for example, the display module 32 in the image perceived from the observation zone 42, so that the intensity of light coming from the observed scene only represents a percentage of between 5 and 95% of the intensity of the image perceived in the observation zone 42.

Advantageously, the observation device 26 comprises a set of buttons associated with an electronic board for adjusting light intensity of the image provided by the display module 32. Thus the observation device 26 adapts to a wide range of weather conditions, such as low light, excessive light or fog.

In another embodiment, the first microdisplay 38 of the display module 32 is also configured to display at least one contextual piece of information. For example, the first microdisplay 38 is configured to display at least one image superimposed on the spectral piece of information measured by the camera 30 and displayed by the first microdisplay 38.

The embodiment illustrated in FIG. 3 is particularly advantageous for making a line of sight or for making a head-up helmet visor for equipping an aircraft pilot in order to contribute to making aircraft flight safer and the pilot's mission more effective. The same applies to the embodiments described hereinafter.

For a rifle scope, the camera 30 is, for example, an infrared camera configured to take measurements in a spectral band close to 10 microns. For a helmet equipping a pilot, the camera 30 is, for example, an infrared camera configured to carry out measurements in a spectral band of between 3 and 5 microns.

Preferably, the first microdisplay 38 is configured to display at least one contextual piece of information in the form of a red dot for improved sighting. Optionally, the observation device 26 comprises a magnifying telescope.

FIG. 4 schematically illustrates an observation device 26 according to a third embodiment wherein the arrangement of optical components 34 comprises three optical surfaces 40, 44, 46 advantageously of the free-form type. The three optical surfaces 40, 44, 46 herein form a free-form type prism. The embodiment of FIG. 4 is a particularly compact one. For example, an upper part of the observation device 26 represented in FIG. 4 is reduced in size relative to the observation device 26 represented in FIG. 3.

The display module 32 is similar to the embodiment of FIG. 2.

Light rays making up the image output by the display module 32 are directed towards a first free-form type optical surface 40, herein a first surface of the free-form type prism. Light rays are transmitted through the first surface of the prism and directed towards a second free-form type optical surface 44, herein a second surface of the prism. Light rays are reflected on the second surface of the prism and are directed towards a third free-form type optical surface 46, herein a third surface of the prism. Light rays are transmitted through the third surface of the prism and directed towards the optical combiner 36.

In another embodiment, the three optical surfaces 40, 44, 46 of the arrangement of optical components 34 comprise a free-form type lens and a free-form type mirror or three free-form type mirrors. The arrangements of the different elements inside the mechanical structure 28 are adapted to the optical surfaces used.

Advantageously, the third embodiment illustrated in FIG. 4 is configured to provide an image at the diffraction limit in the observation zone 42. The same applies to the embodiments described hereinafter.

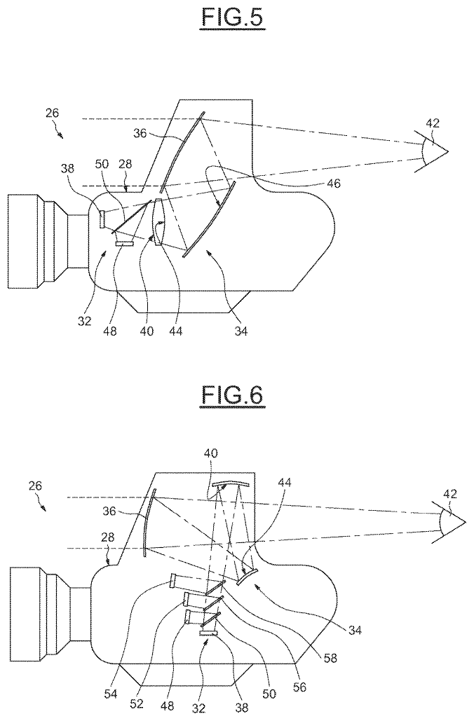

FIG. 5 schematically illustrates an observation device 26 according to a fourth embodiment of the invention wherein the arrangement of optical components 34 comprises three optical surfaces 40, 44, 46, advantageously of the free-form type.

The display module 32 comprises two microdisplays 38, 48 and a second optical combiner 50, advantageously of the free-form type. Furthermore, the display module 32 comprises as its only optical component the second optical combiner 50.

The first microdisplay 38 is similar to the embodiment of FIG. 2. The second microdisplay 48 is configured to display at least one contextual piece of information.

The second optical combiner 50 is configured to overlay the image of the first microdisplay 38 and the image of the second microdisplay 48. Thus, the image output by the display module 32 comprises the spectral piece of information measured by the camera 30 and displayed by the first microdisplay 38 and the contextual piece of information displayed by the second microdisplay 48. For example, the second optical combiner 50 is similar to the optical combiner 36 of FIG. 2 and enables the image of the first microdisplay 38 and the image of the second microdisplay 48 to be overlayed.

Optionally, the first microdisplay 38 is an OLED display optimised in a first defined spectral band, for example a spectral band corresponding to a colour, for example a yellow colour. Thus, the first microdisplay 38 consumes less power than a display capable of displaying colours of the visible spectrum with wavelengths between 400 and 700 nm.

Optionally, the second microdisplay 48 is an OLED display optimised in a second defined spectral band, for example a spectral band corresponding to a colour, for example a red colour. Thus, the second microdisplay 48 consumes less power than a display capable of displaying colours in the visible spectrum with wavelengths between 400 and 700 nm.

Advantageously, the energy consumption of such a first microdisplay 38 added to the energy consumption of such a second microdisplay 48 is less than the energy consumption of a single microdisplay capable of displaying several spectral bands such as colours of the visible spectrum with wavelengths between 400 and 700 nm.

Preferably, the first microdisplay 38 and/or the second microdisplay 48 is configured to display a spectral band adapted to the use of the observation device 26 to achieve better performance.

FIG. 6 schematically illustrates an observation device 26 according to a fifth embodiment wherein the arrangement of optical components 34 comprises two optical surfaces 40, 44 advantageously of the free-form type.

The display module 32 herein comprises four microdisplays 38, 48, 52, 54, including a first microdisplay 38 similar to the first embodiment of FIG. 2 and three additional microdisplays 48, 52, 54, as well as three additional optical combiners 50, 56, 58, for example similar to the optical combiner 36 of FIG. 2. Furthermore, the display module 32 is comprised solely of microdisplays 38, 48, 52, 54 and optical combiners 50, 56, 58.

The second, third and fourth microdisplays 48, 52 and 54 are respectively associated with a second, third and fourth camera (not represented) configured to provide a spectral piece of information about the observed scene. The second, third and fourth microdisplays 48, 52, 54 are configured to display an image of a spectral piece of information provided by the associated camera.

Advantageously, the first additional optical combiner 50 is configured to overlay the image of the third microdisplay 52 and the image of the fourth microdisplay 54 so as to direct this overlayed image towards the second additional optical combiner 56. The second additional optical combiner 56 is configured to overlay the image from the first additional optical combiner 50 and the image from the second microdisplay 48 so as to direct this overlayed image towards the third additional optical combiner 58. The third additional optical combiner 58 is configured to overlay the image from the second additional optical combiner 56 and the image from the first microdisplay 38 so that the image output by the display module 32 comprises the superimposition of the images from the first, second, third and fourth microdisplays 38, 48, 52, 54.

Advantageously, the intensity and spectral bands displayed by the first, second, third and fourth microdisplays 38, 48, 52, 54 are different so that the image perceived in the observation zone 42 by an operator is adapted to the use of the observation device 26.

In one embodiment, the fourth microdisplay 52 is not associated with a camera and is configured to display at least one contextual piece of information.

In another embodiment, the display module 32 comprises a number of microdisplays 48, 52, 54 and optical combiners 50, 56, 58 different from FIG. 6, other arrangements of the microdisplays and optical combiners being possible in the display module 32.

In another embodiment, the number of cameras is greater than the number of microdisplays, the observation device 26 comprising an electronic board configured to display the spectral piece of information measured by several cameras on a microdisplay.

Preferably, the optical components used in the observation device 26, namely the optical combiners 36, 50, 56, 58 and the optical surfaces 40, 44, 46, are defined on the basis of Zernike polynomials. This especially allows better digital representation of these optical components, for example faster convergence of optical system dimensioning software.

Another object of the invention is a method for dimensioning an observation device 26 as previously described comprising, for example, the following steps.

The first step of the dimensioning method corresponds to a step of making a digital model of the observation device 26. The digital model comprises, for example, relative positions of the different optical components and/or microdisplays used and/or limit dimensions of the different optical components used and/or physical overall size restrictions and/or illumination and/or meteorological conditions.

The method then comprises a step of discretising the digital model, for example by a finite element method and/or by a decomposition of the optical components according to a Zernike polynomial basis particularly adapted to the dimensioning of optical systems.

The next step corresponds to a light ray tracing step for checking that the digital model meets a set of specifications comprising, for example, quality of the image from the display device propagated by the arrangement of optical components 34 and/or quality of the overlayed image directed towards the observation zone 42.

Finally, a step of optimising the digital model is carried out, comprising, for example, modifying parameters of the digital model comprising, for example, relative positions and/or dimensions of the optical components.

1. An observation device comprising a mechanical structure, a camera and a display module comprising a first microdisplay configured to display an image of a spectral piece of information measured by the camera, further comprising an optical combiner and an arrangement of optical components configured to direct towards the optical combiner an image output by the display module and comprising the spectral piece of information displayed by the first microdisplay, the arrangement of optical components being an arrangement of optical components of the free-form type comprising between one and three optical surfaces of the free-form type, the optical combiner directing towards an observation zone the superimposition of an image of an observed scene and of the image output by the display module.

2. The device according to claim 1, wherein the optical combiner is of the free-form type.

3. The device according to claim 1, wherein the optical combiner comprises a free-form type dichroic filter or a free-form type semi-reflective mirror or a free-form type splitter cube.

4. The device according to claim 1, wherein the optical combiner of the free-form type comprises a free-form optical component comprising two identical surfaces translated from one another along a line of sight of the scene so as to be of constant thickness along the line of sight.

5. The device according to claim 1, comprising a moving attenuating filter configured to be placed upstream of the optical combiner on an optical path of light rays passing through the optical combiner.

6. The device according to claim 1, wherein the arrangement of optical components comprises at least two optical surfaces of the free-form type.

7. The device according to claim 1, wherein the arrangement of optical components comprises three optical surfaces of the free-form type.

8. The device according to claim 1, wherein the first microdisplay is also configured to display at least one contextual piece of information.

9. The device according to claim 1, wherein the display module comprises a second microdisplay configured to display at least one contextual piece of information and a second optical combiner configured to overlay the image of the first microdisplay and the image of the second microdisplay so that the image output by the display module also comprises the contextual piece of information displayed by the second microdisplay.

10. The device according to claim 1, wherein the display module comprises one or more additional microdisplays each associated with an additional camera and configured to display an image of an additional spectral piece of information measured by said associated camera, the display module comprising one or more additional optical combiners configured such that the image output by the display module also comprises the information displayed by the additional microdisplays.

11. The device according to claim 7, wherein the three optical surfaces of the free-form type form a free-form type prism.
